(19) United States
(12) Patent Application Publication
(10) Pub. No.: US 2007/0154675 A1
(43) Pub. Date: Jul. 5, 2007

(54) Optical information storage medium

(75) Inventors: Huang Shiang Yang, Taipei County (TW); Han-Yi Chang, Taipei County (TW); Zhi-Zhong Wang, Changhua City (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/339,512

(22) Filed: Jan. 26, 2006

(30) Foreign Application Priority Data
Jan. 5, 2006 (TW) 095100523

(51) Int. Cl. B32B 3/02

(52) U.S. Cl. 428/64.4

(57) ABSTRACT

An optical information storage medium includes at least one substrate, at least one recording layer, and at least one thermal diffusing layer. In this case, the recording layer is disposed over the substrate, and the thermal diffusing layer is disposed at one side of the recording layer. If the recording layer is composed of an endothermic-exothermic mixed material, the thermal conductivity coefficient of the thermal diffusing layer is approximately smaller than 10 W/m-K. If the recording layer is composed of an exothermic material, the thermal conductivity coefficient of the thermal diffusing layer is approximately greater than 10 W/m-K.

### BACKGROUND OF THE INVENTION

1. Field of Invention

The invention relates to an optical information storage medium and, in particular, to a writeable/rewriteable optical information storage medium.

2. Related Art

Due to the progress of multimedia, the demands of storage medium in electronic products regarding to storage density and capacity are increasing. Conventional storage medium could be divided into the magnetic information storage medium and the optical information storage medium. Optical information storage medium is greatly applied to the present electronic products, and it includes the read-only CD (CD-ROM), write-once CD (CD-R), rewritable CD (CD-RW), read-only DVD (DVD-ROM), write-once DVD (DVD-R), rewritable DVD (DVD-RW), random-access DVD (DVD-RAM), high definition DVD (HD DVD-R/-RW/-RAM), and blu-ray disc (BD-R/-RE).

Regarding to the optical storage medium, the write-once CD (CD-R), rewritable CD (CD-RW), the user can record the necessary data in the write-once DVD (DVD-R), rewritable DVD (DVD-RW), random-access DVD (DVD-RAM), high definition DVD (HD DVD-R/-RW/-RAM), and blu-ray disc (BD-R/-RE) with a recorder. The recorder can generate a laser beam to form, for example, pits on a recording layer of the optical storage medium for recording the data.

However, if the heat caused by the light spot of the laser beam formed on the optical information storage medium can not be removed efficiently, or if the energy of the laser beam can not be dissipated in time, the formed pits may not be qualified for the required standards. Accordingly, the optical pick-up head may not correctly read the information recorded in the optical information storage medium.

In addition, since the material of the recording layer is various, such as the cyanine dye, the AZO dye, or the phase change material, the heat dissipation ability of the recording layer depends. Therefore, the sizes of the pits formed on the recording layer may not be properly controlled within the required standard.

Therefore, it is an important subject of the invention to provide an optical information storage medium that can efficiently facilitate the heat dissipation of the recording layer according to the material characteristic of the recording layer.

### SUMMARY OF THE INVENTION

In view of the foregoing, the invention is to provide an optical information storage medium that can efficiently facilitate the heat dissipation of the recording layer according to the material characteristic of the recording layer.

To achieve the above, an optical information storage medium of the invention includes at least one substrate, at least one recording layer, and at least one thermal diffusing layer. In the invention, the recording layer is disposed over the substrate, and the thermal diffusing layer is disposed at one side of the recording layer. When the recording layer is composed of an endothermic-exothermic mixed material, the thermal conductivity coefficient of the thermal diffusing layer is approximately smaller than 10 W/m-K. When the recording layer is composed of an exothermic material, the thermal conductivity coefficient of the thermal diffusing layer is approximately greater than 10 W/m-K.

As mentioned above, the optical information storage medium of the invention has a thermal diffusing layer located at one side of the recording layer, so that the thermal diffusing layer can facilitate to dissipate heat of the recording layer. In addition, the invention adopts the thermal diffusing layer of different thermal conductivity coefficient according to the material characteristic of the recording layer. Thus, the heat of the recording layer of the invention can be properly dissipated based on its material characteristic. During a burning process, the optical information storage medium of the invention can dissipate the energy of the laser beam in time, so that the formed pits can be qualified for the required standards. Accordingly, the reading error of the information recorded in the optical information storage medium can be prevented, and, furthermore, the burning power consumption of the optical disc drive can be reduced.

### BRIEF DESCRIPTION OF THE DRAWINGS

The invention will become more fully understood from the detailed description given herein below illustration only, and thus is not limitative of the present invention, and wherein:

FIG. 1 is a schematic view showing an optical information storage medium according to a preferred embodiment of the invention;

FIG. 2A is a schematic diagram showing a measured thermal behavior (enthalpy) of an endothermic-exothermic mixed material such as a cyanine dye;

FIG. 2B is a schematic diagram showing a measured thermal behavior (enthalpy) of an exothermic material such as an AZO dye;

FIG. 3 is a schematic view showing an optical information storage medium, which includes a reflecting layer, according to another preferred embodiment of the invention;

FIG. 4 is a schematic view showing an optical information storage medium according to still another preferred embodiment of the invention, wherein the thermal diffusing layer is located between the substrate and the recording layer;

FIG. 5 is a schematic view showing an optical information storage medium, which includes two thermal diffusing layers, according to yet another preferred embodiment of the invention; and

FIG. 6 is a schematic view showing an optical information storage medium, which is a single-side double-layer DVD-R, according to still yet another preferred embodiment of the invention.

### DETAILED DESCRIPTION OF THE INVENTION

The present invention will be apparent from the following detailed description, which proceeds with reference to the accompanying drawings, wherein the same references relate to the same elements.

The disclosed optical information storage medium according to a preferred embodiment of the invention is the recordable optical disc, such as a write-once CD (CD-R), a rewritable CD (CD-RW), a single/multi layer write-once DVD (single/multi layer DVD-R), a rewritable DVD (DVD-RW), random-access DVD (DVD-RAM), a single/multi layer HD DVD (single/multi layer HD DVD-R/-RW/-RAM), or a single/multi layer BD (single/multi layer BD-R/-RE)

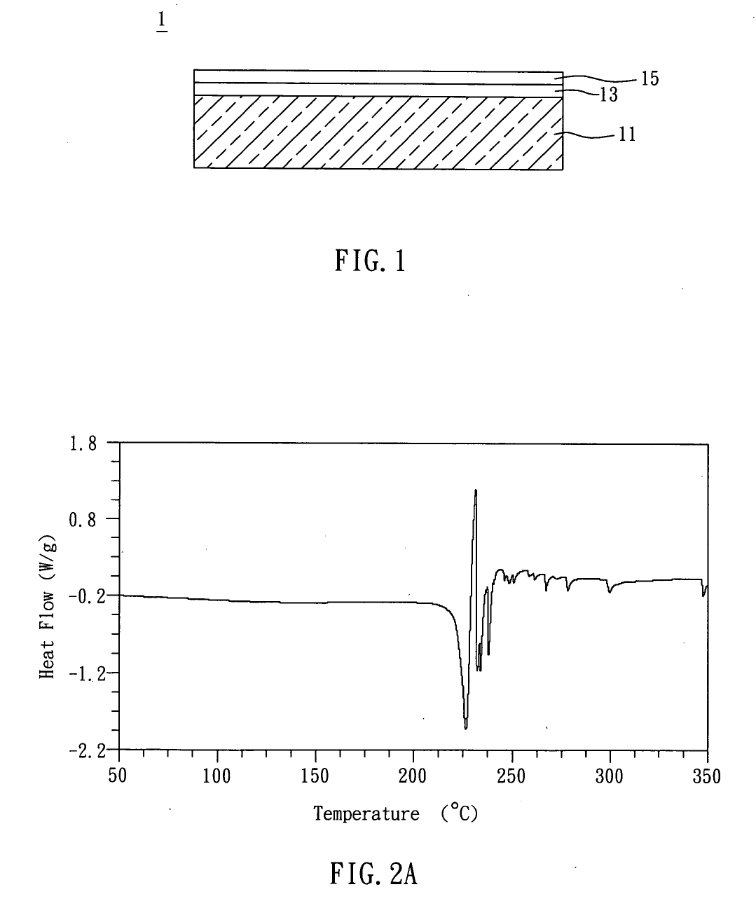

First, the write-once CD (CD-R) and rewritable CD (CD-RW) will be described for example. With reference to FIG. 1, an optical information storage medium 1 includes a substrate 11, a recording layer 13, and a thermal diffusing layer 15.

As shown in FIG. 1, the recording layer 13 is disposed on the substrate 11, and the thermal diffusing layer 15 is disposed on the recording layer 13. In the current embodiment, the substrate 11 has a thickness of approximate 12 mm. The recording layer 13 is formed on the substrate 11 by a spin-coating process. The material of the recording layer 13 may be an organic material or an inorganic material, such as a cyanine dye, an AZO dye, or a phase change material. The thickness of the recording layer 13 is approximate between 50 nm and 140 nm. The thickness of the thermal diffusing layer 15 is approximate between 1 nm and 50 nm. The material of the thermal diffusing layer 15 may be a metal material or a ceramic material, such as a silicon-based compound, a tantalum-based compound, an aluminum-based compound, a silver-based compound, MgO—SiO₂, 2MgO—SiO₂, or ZnS—SiO₂.

In the present embodiment, when the recording layer 13 is composed of an endothermic-exothermic mixed material, the thermal conductivity coefficient of the thermal diffusing layer 15 is approximately smaller than 10 W/m-K. Otherwise, when the recording layer 13 is composed of an exothermic material, the thermal conductivity coefficient of the thermal diffusing layer 15 is approximately greater than 10 W/m-K. To be noted, the recording layer 13 may be composed of other material(s), such as the molding material or solvent for assisting in forming the endothermic-exothermic mixed material or the exothermic material on the substrate 11.

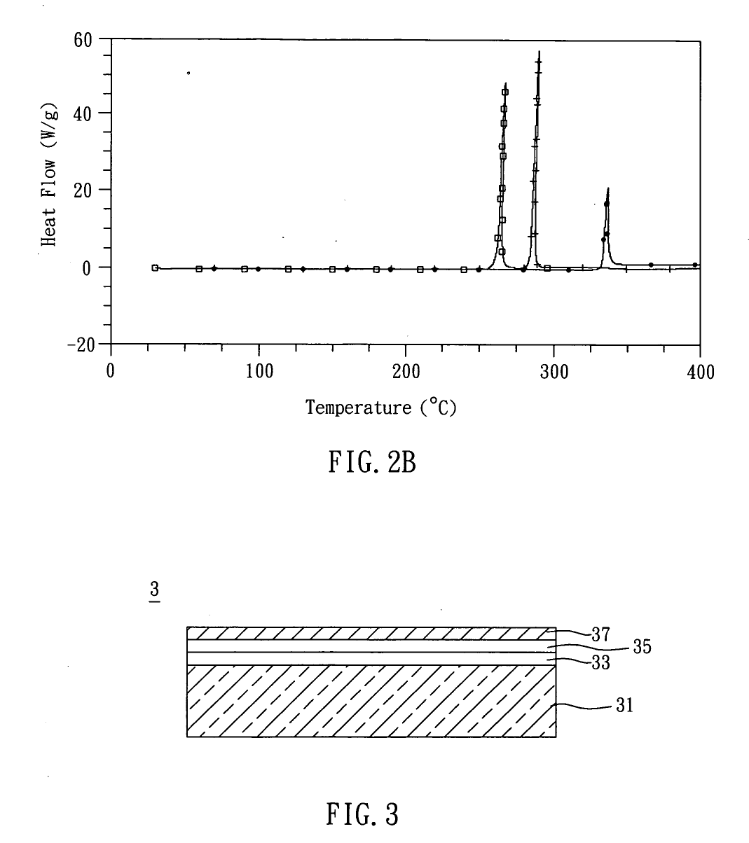

In more details, during a burning process, the endothermic-exothermic mixed material has an endothermic behavior and an exothermic behavior, and the exothermic material has only an exothermic behavior. In the embodiment, the endothermic-exothermic mixed material of the recording layer 13 is, for example, a cyanine dye. When we measured the thermal behavior (enthalpy) of the cyanine dye with a DSC (Differential Scanning Calorimeter), the result can be obtained as the diagram showing in FIG. 2A. Regarding to the measured diagram showing in FIG. 2A, we can find that the cyanine dye will perform an endothermic action first and then an exothermic action. It is obvious that the cyanine dye is an endothermic-exothermic mixed material. In addition, the exothermic material of the recording layer 13 is, for example, an AZO dye or a phase change material. Taking the AZO dye as an example, when we measured the thermal behavior (enthalpy) of the AZO dye with a DSC, the result can be obtained as the diagram showing in FIG. 2B. Regarding to the measured diagram showing in FIG. 2B, we can find that the AZO dye will perform one or more exothermic actions. It is obvious that the AZO dye is an exothermic material. In this case, the exothermic peaks of the exothermic material is higher and sharper, so the adopted thermal diffusing layer 15 must be composed of the material of larger thermal conductivity coefficient for facilitating the heat dissipation.

In this embodiment, to facilitate the heat dissipation of the recording layer 13 efficiently, the material of the thermal diffusing layer 15 must be selected depending on the material characteristic of the recording layer 13. For instance, if the recording layer 13 is composed of the endothermic-exothermic mixed material, the thermal diffusing layer 15 may be made of ZnS—SiO₂, TiO₂, or SiO₂. In this case, ZnS—SiO₂ has a thermal conductivity coefficient of 9 W/m-K, TiO₂ has a thermal conductivity coefficient of 6.5 W/m-K, and SiO₂ has a thermal conductivity coefficient of 0.9 W/m-K. In addition, if the recording layer 13 is composed of the exothermic material, the thermal diffusing layer 15 may be made of SiN, SiC, Al₂O₃, AlN, or TiN. In this case, SiN has a thermal conductivity coefficient of 20 W/m-K, SiC has a thermal conductivity coefficient of 41 W/m-K, Al₂O₃ has a thermal conductivity coefficient of 30 W/m-K, AlN has a thermal conductivity coefficient of 16 W/m-K, and TiN has a thermal conductivity coefficient of 41W/m-K. To be noted, the above thermal conductivity coefficients are all measured at the temperature of 373K. In brief, the invention can control the thermal diffusing effect of multiple layers, so that the better thermal reservoir control can be obtained.

As shown in FIG. 1, the thermal diffusing layer 15 of the embodiment is made of a metal material, so that it can provide the function as a reflecting layer. Thus, when an optical disc drive is used to read the information recorded in the optical information storage medium 1, the thermal diffusing layer 15 can reflect the laser beam emitted from the optical pick-up head of the optical disc drive. In this case, the optical disc drive can correctly read the information recorded in the optical information storage medium 1.

To be noted, the thermal diffusing layer 15 may equip other functions, such as a protection layer, a barrier layer for preventing water or oxidation, a thermal diffusing source or a heat inhibiting source of part of the multi layer optical information storage medium (high speed recording optical disc), or the likes. Furthermore, the thermal diffusing layer 15 should not affect the recording property of the optical information storage medium.

With reference to FIG. 3, an optical information storage medium 3 according to another preferred embodiment of the invention includes a substrate 31, a recording layer 33, a thermal diffusing layer 35, and a reflecting layer 37. In this embodiment, the features and functions of the substrate 31, recording layer 33 and thermal diffusing layer 35 are the same as those of the substrate 11, recording layer 13 and thermal diffusing layer 15 in the previous embodiment, so the detailed descriptions are omitted for concise purpose.

In the current embodiment, the recording layer 33, thermal diffusing layer 35 and reflecting layer 37 are disposed over the substrate 31 in order. That is, the thermal diffusing layer 35 is located between the recording layer 33 and the reflecting layer 37. In this case, the thermal diffusing layer 35 may be transparent, so that the laser beam can pass through the thermal diffusing layer 35. Therefore, when an optical disc drive is used to read the information recorded in the optical information storage medium 3, the reflecting layer 37 can reflect the laser beam emitted from the optical pick-up head of the optical disc drive. Accordingly, the optical disc drive can correctly read the information recorded in the optical information storage medium 3.

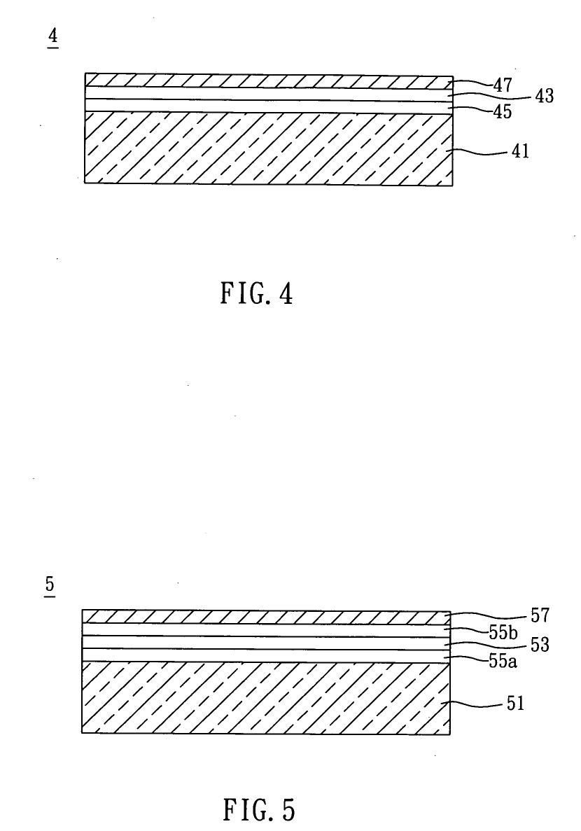

With reference to FIG. 4, an optical information storage medium 4 according to still another preferred embodiment of the invention includes a substrate 41, a recording layer 43, a thermal diffusing layer 45, and a reflecting layer 47. In this embodiment, the features and functions of the substrate 41, recording layer 43, thermal diffusing layer 45 and reflecting layer 47 are the same as those of the substrate 31, recording layer 33, thermal diffusing layer 35 and reflecting layer 37 in the previous embodiment, so the detailed descriptions are omitted for concise purpose.

In the present embodiment, the thermal diffusing layer 45, recording layer 43, and reflecting layer 47 are disposed over the substrate 41 in order. That is, the thermal diffusing layer 45 is located between the recording layer 43 and the substrate 41. In this case, the thermal diffusing layer 45 may be transparent, so that the laser beam can pass through the thermal diffusing layer 45. Therefore, when an optical disc drive is used to read the information recorded in the optical information storage medium 4, the reflecting layer 47 can reflect the laser beam emitted from the optical pick-up head of the optical disc drive. Accordingly, the optical disc drive can correctly read the information recorded in the optical information storage medium 4.

Of course, the optical information storage medium of the invention may include multiple thermal diffusing layers. With reference to FIG. 5, an optical information storage medium 5 according to yet another preferred embodiment of the invention includes a substrate 51, a recording layer 53, two thermal diffusing layers 55a and 55b, and a reflecting layer 57. In this embodiment, the features and functions of the substrate 51, recording layer 53 and reflecting layer 57 are the same as those of the substrate 51, recording layer 53 and reflecting layer 57 in the previous embodiment, so the detailed descriptions are omitted for concise purpose. The features and functions of the thermal diffusing layers 55a and 55b are the same as those of the thermal diffusing layer 15 in the previous embodiment, so the detailed descriptions are also omitted for concise purpose

In this embodiment, the thermal diffusing layer 55a, recording layer 53, thermal diffusing layer 55b, and reflecting layer 57 are disposed over the substrate 51 in order. That is, the recording layer 53 is located between the thermal diffusing layers 55a and 55b. In this case, the thermal diffusing layers 55a and 55b may be transparent, so that the laser beam can pass through them. Therefore, when an optical disc drive is used to read the information recorded in the optical information storage medium 5, the reflecting layer 57 can reflect the laser beam emitted from the optical pick-up head of the optical disc drive. Accordingly, the optical disc drive can correctly read the information recorded in the optical information storage medium 5.

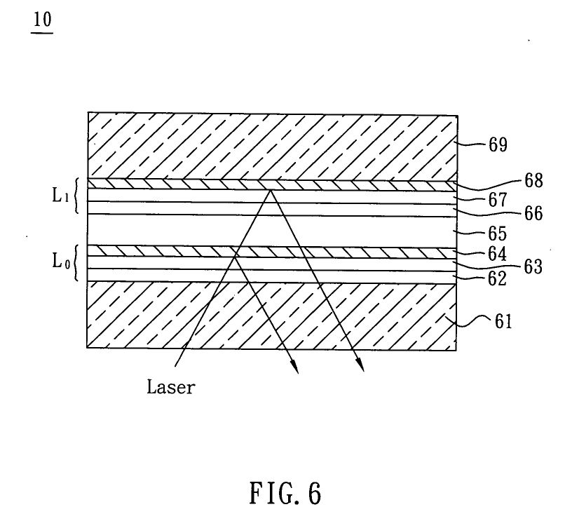

Moreover, the optical information storage medium of the invention may be a recordable DVD. Taking a single-side double-layer DVD-R as an example, with reference to FIG. 6, an optical information storage medium 6 according to still yet another preferred embodiment of the invention mainly includes a first substrate 61, a first recording layer 62, a first thermal diffusing layer 63, a first reflecting layer 64, a spacer layer 65, a second thermal diffusing layer 66, a second recording layer 67, a second reflecting layer 68 and a second substrate 69. In this embodiment, the first recording layer 62, the first thermal diffusing layer 63 and the first reflective layer 64 compose a first recording stack layer (L₀), and the second thermal diffusing layer 66, the second recording layer 67 and the second reflective layer 68 compose a second recording stack layer (L₀). The first recording stack layer (L₀) and the second recording stack layer (L₁) are respectively formed on the data sides of the first substrate 61 and the second substrate 69. The spacer layer 65 is disposed between the first recording stack layer (L₀) and the second recording stack layer (L₁). When reading out data stored in the optical information storage medium 6, the laser beam will pass through the first substrate 61 and focus on the first recording stack layer L₀ or further pass through the spacer layer 65 and focus on the second recording stack layer L₁. The materials of the first thermal diffusing layer 63 and the second thermal diffusing layer 66 are selected depending on the materials of the first recording layer 62 and the second recording layer 67, respectively. The rules for selecting the proper materials are as those described hereinabove, so the detailed descriptions are omitted for concise purpose. Besides, the locations of the thermal diffusing layers and the amount thereof can be determined based on the actual needs. Thus, the heat energy can be removed efficiently without increasing the burning power of the optical disc drive.

In summary, the optical information storage medium of the invention has a thermal diffusing layer located at one side of the recording layer, so that the thermal diffusing layer can facilitate to dissipate heat of the recording layer. In addition, the invention adopts the thermal diffusing layer of different thermal conductivity coefficient according to the material characteristic of the recording layer. Thus, the heat of the recording layer of the invention can be properly dissipated based on its material characteristic. During a burning process, the optical information storage medium of the invention can dissipate the energy of the laser beam in time, so that the formed pits can be qualified for the required standards. Accordingly, the reading error of the information recorded in the optical information storage medium can be prevented, and, furthermore, the burning power consumption of the optical disc drive can be reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical information storage medium, comprising:
at least one substrate;
at least one recording layer disposed over the substrate; and
at least one thermal diffusing layer disposed at one side of the recording layer, wherein when the recording layer is composed of an endothermic-exothermic mixed material, a thermal conductivity coefficient of the thermal diffusing layer is approximately smaller than 10 W/m-K, and when the recording layer is composed of an exothermic material, the thermal conductivity coefficient of the thermal diffusing layer is approximately greater than 10 W/m-K.

2. The optical information storage medium of claim 1, further comprising:
at least one reflecting layer, wherein the recording layer is located between the reflecting layer and the substrate.

3. The optical information storage medium of claim 2, wherein the thermal diffusing layer is located between the reflecting layer and the recording layer.

4. The optical information storage medium of claim 1, wherein the thermal diffusing layer is located between the substrate and the recording layer.

5. The optical information storage medium of claim 1, further comprising:
an additional thermal diffusing layer, wherein the recording layer is disposed between the thermal diffusing layer and the additional thermal diffusing layer.

6. The optical information storage medium of claim 1, wherein the endothermic-exothermic mixed material has an endothermic behavior and an exothermic behavior during a burning process.

7. The optical information storage medium of claim 1, wherein the exothermic material has an exothermic behavior during a burning process.

8. The optical information storage medium of claim 1, wherein when the recording layer is composed of the endothermic-exothermic mixed material, the thermal diffusing layer is made of ZnS—SiO2, TiO2, or SiO2.

9. The optical information storage medium of claim 1, wherein when the recording layer is composed of the exothermic material, the thermal diffusing layer is made of SiN, SiC, Al2O3, AlN, or TiN.

10. The optical information storage medium of claim 1, wherein the material of the thermal diffusing layer is a metal material or a ceramic material.

11. The optical information storage medium of claim 10, wherein the material of the thermal diffusing layer is a silicon-based compound, a tantalum-based compound, an aluminum-based compound, a silver-based compound, MgO—SiO2, 2MgO—SiO2, or ZnS—SiO2.

12. The optical information storage medium of claim 1, wherein a thickness of the recording layer is approximate between 50 nm and 140 nm.

13. The optical information storage medium of claim 1, wherein a thickness of the thermal diffusing layer is approximate between 1 nm and 50 nm.

14. The optical information storage medium of claim 1, wherein the endothermic-exothermic mixed material of the recording layer is a cyanine dye.

15. The optical information storage medium of claim 1, wherein the exothermic material of the recording layer is an AZO dye or a phase change material.

16. The optical information storage medium of claim 1, wherein the optical information storage medium is a write-once CD (CD-R), a rewritable CD (CD-RW), a single/multi laser write-once DVD (single/multi layer DVD-R), a rewritable DVD (DVD-RW), random-access DVD (DVD-RAM), a single/multi layer HD DVD (single/multi layer HD DVD-R/-RW/-RAM), or a single/multi layer BD (single/multi layer BD-R/-RE).
